(19) United States
(12) Patent Application Publication
(10) Pub. No.: US 2012/0102770 A1
(43) Pub. Date: May 3, 2012

(54) DC line wedge

(76) Inventor: Fidel Garcia Ramos, Abilene, TX (US)

(21) Appl. No.: 13/199,425

(22) Filed: Aug. 29, 2011

Related U.S. Application Data
(60) Provisional application No. 61/402,695, filed on Sep. 3, 2010.

(51) Int. Cl. G01B 1/00

(52) U.S. Cl. 33/407

(57) ABSTRACT

The “DC LINE WEDGE” Is a Bricklaying and Stone masons tool that is designed to hold a string line in a brick pocket. It consist of two parts, the “Head” which is milled in an angle with a string hole at the center to accept a string line and the “body” to accept the head. The “brick pocket” is the area between the framed wall and the brick molding in which the brick is tucked behind to simulate a finished wall.

Insert the DC Line Wedge into the brick pocket horizontally with the head against the brick mold with the body angled slightly towards the end that holds the other side of the string. If it does not stay in place when tension is applied, simply unscrew the head to lengthen the tool until it stays in place when tension is applied.

### CROSS REFERENCE TO THE RELATED APPLICATION BASED ON A PROVISIONAL APPLICATION

Application No. (61/402,695) Filing date Sept. 3, 2010

The DC LINE WEDGE is a Bricklayer and Stonemasons tool. It is designed to hold a string Line securely in a brick pocket. (A“Brick Pocket” is the area between the framed wall and the molding in which a brick is tucked behind to simulate a finished wall) The brick pocket is usually between 4 inches and 5½ inches. The DC LINE WEDGE consist of two metal parts “The Head” and “The Body”.

The Head is made of a 3″× 5/16×18 rounds per inch Hex head bolt with a ½ Hex head. It has a 30 degree milled cut from the top center from point to point directly downward away from the center of the bolt. The milled cut does not go all the way to the bottom of the Hex head. After it has been milled a hole is drilled to allow a string line to be threaded through, this string hole is drilled with a ⅛ of an inch metal bit, it is drilled at a 45 degree angle directly away from the milled area from the center of the top of the bolt directly away from the milled cut.

“The Body” is made of a Hexagonal Aluminum tube. It is made of a 9/16 of an inch hexagonal tube with the center hollowed area being ⅜ of an inch. The tube is cut to a length of 3 inches. It is then crimped at one end (we'll call this end the top). The crimped portion will only be from the top 1 inch downward and is crimped to a size of outside dimensions of ½ inch in diameter. It is then threaded at the crimped end to receive a ⅚ of an inch at 18 rounds per inch hex bolt.

To complete the DC LINE WEDGE simply screw “The Head” into “The Body”, it is now adjustable from its smallest length of 3¼ inches to it's longest length of 5¾ inches.

When two wall of a structure come together to make a 90-degree inside corner and only one of the walls is to be bricked, a brick mold is attached to the wall that is not going to be bricked from the floor to the ceiling and about 5 inches from the wall that is to be bricked, this area is called the “brickPocket”.

To use the DC LINE WEDGE, you simply thread the string line through the top of the head tying a knot at the bottom so the string will not pull through, and then you insert the DC LINE WEDGE Into the brick pocket horizontally with the head portion against the brick mold and the body slightly angled towards the direction of the opposite end of the string line. If the DC Line wedge is not long enough to stay in place when tension is applied at the opposite end, simply unscrew the head to lengthen the adjustment until it wedges enough to stay in place.

### DRAWINGS

The DC Line Wedge is a specialty tool Specifically designed to address masonry wall closers such as brick pockets. It consist of only two parts, the “head” and the “body”. The head is made from a 3 inch× 5/16 hexagonal head bolt at 18 rounds per inch with the head being ½ inch. The body is made of a 3 inch long, hollow hexagonal Aluminum tube which has been modified at one end to accept the “head”. The drawings attached will give a visual understanding of it's design and application.

FIG. 1, illustrates a standard 3 inch hex bolt with a ½ inch hexagonal head, numeral 2 illustrates the milled screw head at the center of the head from point to point at a 30 degree angle and numeral 3 illustrates the threads of the bolt which are 18 rounds per inch.

FIG. 2, numeral 1 illustrates the ⅛ of an inch drilled string hole at at a 45 degree angle directly away from the milled angle that a string is to be threaded through from the top down.

FIG. 3, numeral 1 illustrates the string line threaded from the top with a double knot tied at the bottom so as not to pull back through.

FIG. 4, numeral 1 illustrates the 9/16 hollow hexagonal Aluminum tube 3 inches long, numeral 2 illustrates the top 1 inch crimped down to a ½ diameter and numeral 3 illustrates the hollowed area of the tube being ⅜ of an inch.

FIG. 5, numeral 1 illustrates after crimping the size of the hole that will accept the head being 5/16 and numeral 2 illustrates the top crimped area being threaded with 5/16 threads at 18 rounds per inch to accept the head.

FIG. 6, illustrates the “head” inserted into the “body”, with the string line threaded from the top and a double knot at the bottom so as the string will not pull back through. When the head is screwed all the way into the body the line wedge is at it's smallest adjustment of 3¼ inches and when it is unscrewed leaving ½ inch of threads inside of the body it is at it's longest length of 5 3/4 inches

FIG. 7, numeral 1 illustrates the framed wall of a building, numeral 2 illustrates a string line running horizontally that is attached to the DC Line Wedge, numeral 3 illustrates the DC Line Wedge tucked into the brick pocket with the head up against the brick mold and the body against the framed wall, numeral 4 illustrates the brick mold and numeral 5 illustrates the brick pocket.

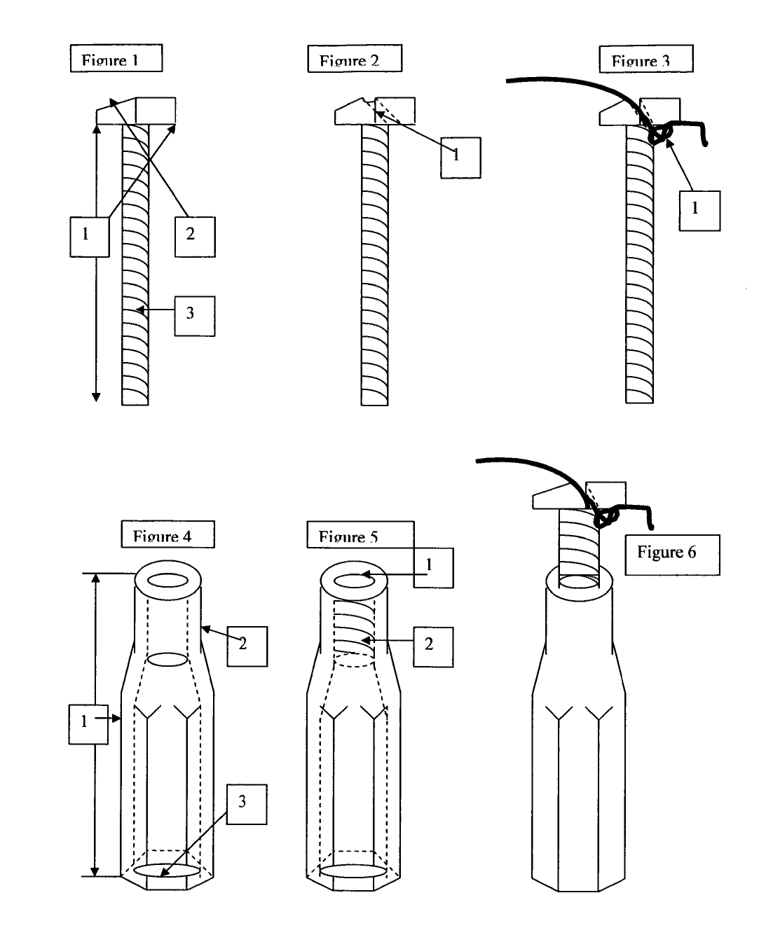

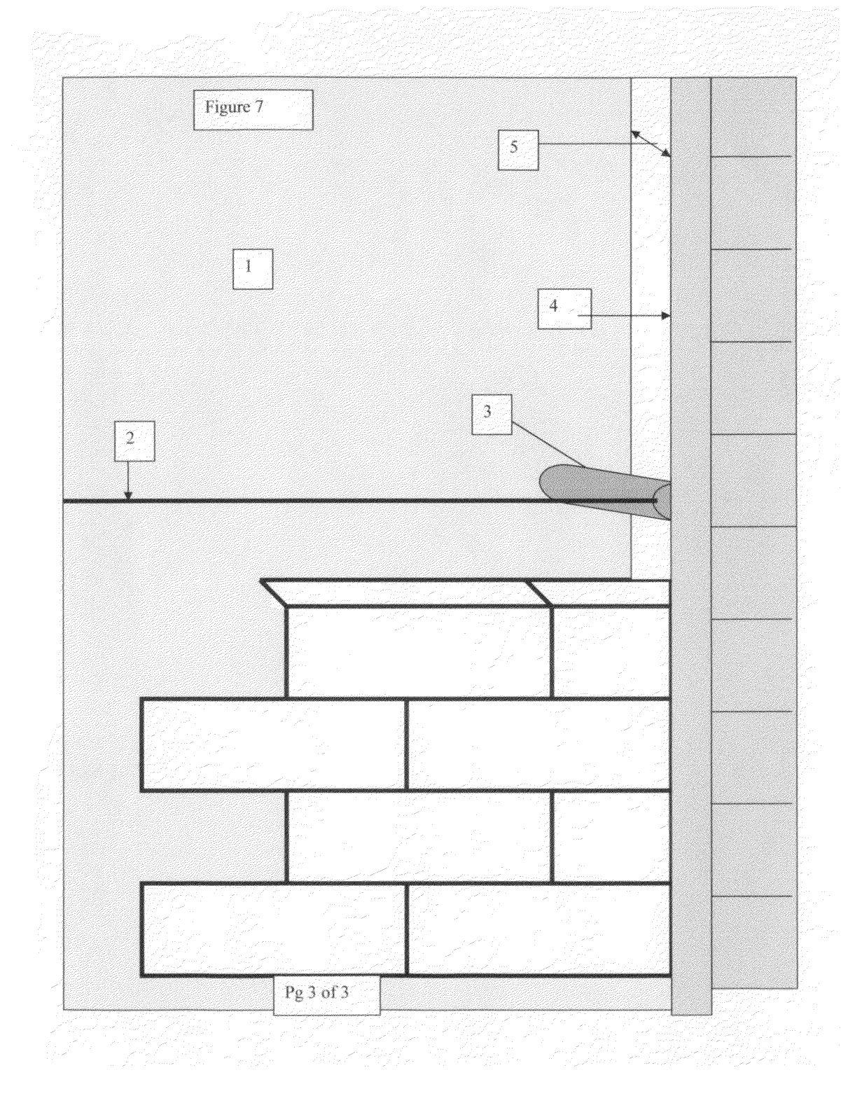

1. The “DC LINE WEDGE” Is a Bricklaying or Stone masons tool that is designed to hold a string line for laying brick or stone in a horizontal into a brick pocket. I have been a brick and stone mason for over 35 years and I have never come across or heard of a tool that holds a string line in what we in my trade call a “Dead Corner” so I designed one. I've been using my tool for about 7 years now and I am still astounded that no one has developed a similar tool to address this certain area.
Masons still to this day still use the old style methods taught to us by our predecessors. One method is to cut a small board about one inch wide and slightly longer then the brick pocket, cut a groove at the top center of one end, but when the brick pocket size changes slightly as you go up the wall, the board then becomes to small and slips out which means you must find another board and repeat the process which is time consuming. My DC Line Wedge saves time and has some unique features and advantages.
The DC Line Wedge with it's hexagonal body keeps it from slipping and twisting out of place. The milled angle at the top of the head along with the hole drilled into the top is unlike any other string line holder that is available to the masonry industry.
The DC Line Wedge is also adjustable from 3¼ to 5¾ inches to accommodate for different sizes of brick pockets. The DC Line Wedge with it's size, shape and adjustability makes it different from any other string line holder.
